(19) United States
(12) Patent Application Publication
(10) Pub. No.: US 2005/0275188 A1
(43) Pub. Date: Dec. 15, 2005

(54) Unicycle assembly

(76) Inventor: Yun Lea Lee, Soo An City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/866,736

(22) Filed: Jun. 15, 2004

(51) Int. Cl. B62K 1/00

(52) U.S. Cl. 280/205

(57) ABSTRACT

A unicycle includes a circular frame composed of at least two sectors connected with each other the circular frame includes an outer ring, an inner ring, a plurality of spokes connected between the outer and inner rings, and a tire engaged with the outer ring. A driving wheel is rotatably engaged with a groove in the inner ring and driven by two crank and pedals. Two circular sub-frames are located on two sides of the circular frame and three rollers are connected to the two sub-frames and rotatably engaged with the groove in the inner ring. A bench and two handles are connected to the cub-frames, and a brake mechanism is connected to the inner ring so as to brake one of the three rollers.

### FIELD OF THE INVENTION

The present invention relates to a compact unicycle which is composed of several sections for convenience of assembling and equipped with a brake mechanism.

### BACKGROUND OF THE INVENTION

Two conventional unicycles known to applicant are disclosed in China Patent No. 97239993.3 and 02311995.0. The 97239993.3 disclose a unicycle with a bulky frame which is inconvenience for transportation and storage. Besides, these unicycles do not have any brake feature so that the players have to control the unicycle with skill and cautions, this restrict many people from playing the unicycles. Furthermore, a large unicycle requires a large diameter tire which cost a lot.

The present invention intends to provide a unicycle composed of six sections and includes a compact frame, a brake mechanism is used to easily brake the unicycle.

### SUMMARY OF THE INVENTION

The present invention relates to a unicycle which comprises a circular frame composed of at least two sectors connected with each other. Each sector includes a section of an outer ring, a section of an inner ring, a plurality of spokes connected between the outer and inner rings, and a section of a tire engaged with the outer ring. A driving wheel is rotatably engaged with a groove defined in the inner ring and driven by two crank and pedals on two sides of the driving wheel. Two circular sub-frames are located on two sides of the circular frame and three rollers are connected to the two sub-frames and rotatably engaged with the groove in the inner ring. A bench and two handles are connected to the sub-frames. A brake mechanism is connected to the inner ring so as to brake one of the three rollers.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view of the unicycle of the present invention;

FIG. 2 is an end view to show a part of the unicycle of the present invention;

FIG. 3 shows that two sectors of the circular frame are connected with each other;

FIG. 4 shows that two sectors of the circular frame are connected with each other, wherein the section of tire is connected between the two adjacent sectors;

FIG. 5 shows the brake mechanism of the present invention, and

FIG. 6 shows that the brake member is pivoted to brake the roller.

### DETAILED DESCRIPTION OF THE PREFERRED EMBODIMENT

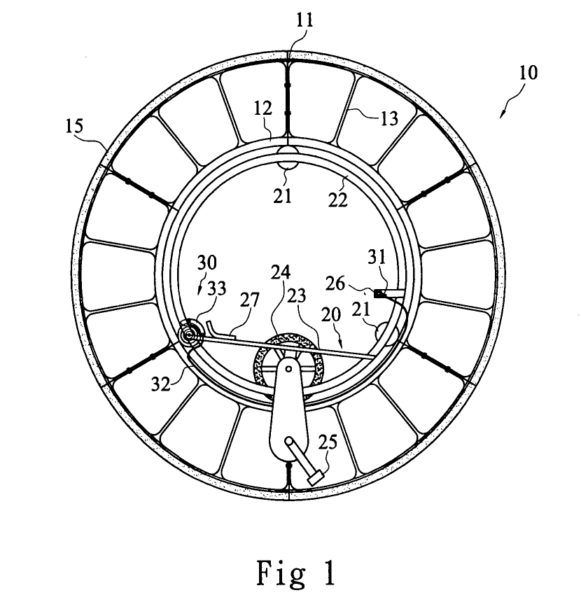

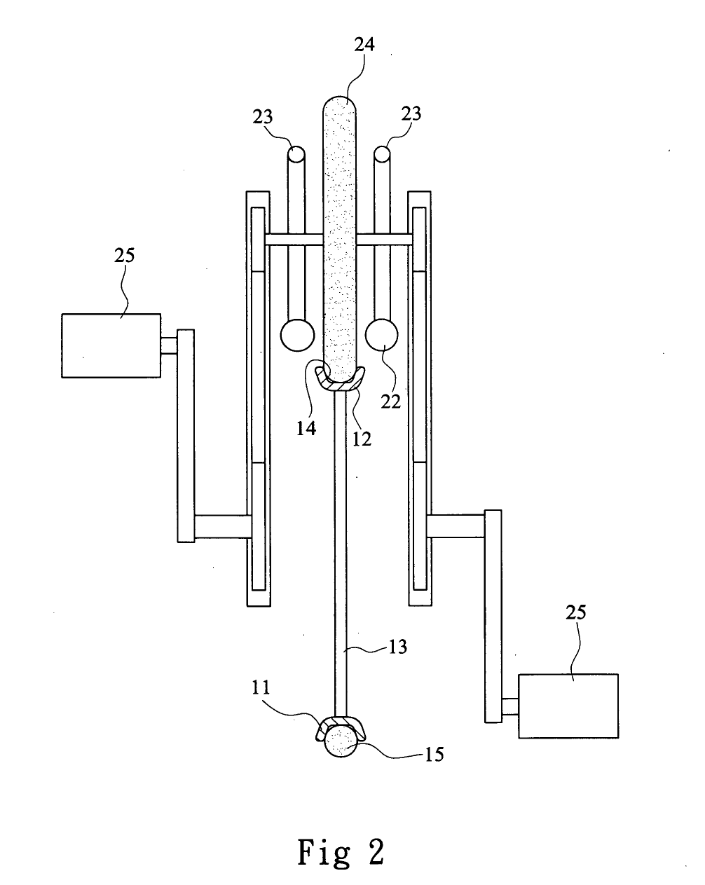

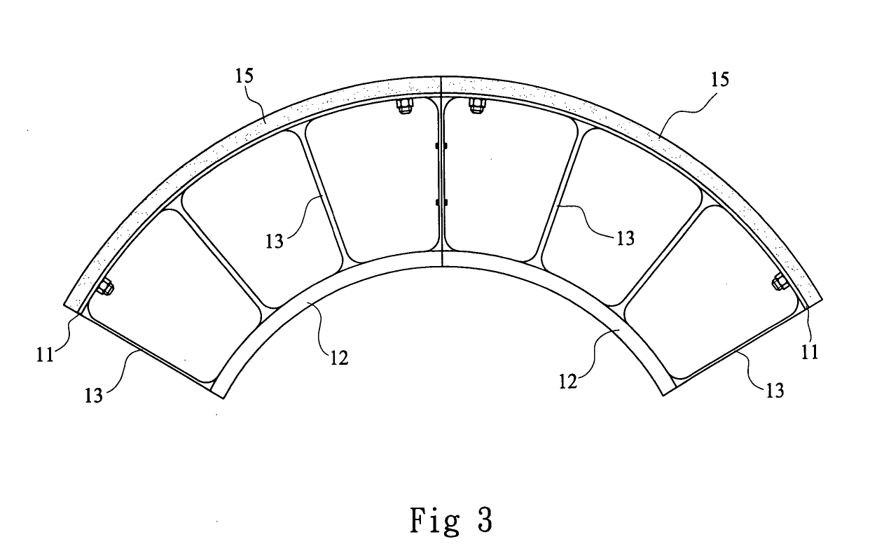

Referring to FIGS. 1 to 3, the 1. A unicycle 10 of the present invention comprises a circular frame composed of at least two sectors connected with each other. A number of the sectors can be 2 to 12 so that the unicycle can be disengaged into sectors which are convenient for storage and transportation. As shown in FIG. 3, two adjacent sectors are connected with each other. Each sector includes a section of an outer ring 11, a section of an inner ring 12, a plurality of spokes 13 connected between the outer and inner rings 11, 12, and a section of a tire 15 engaged with the outer ring 11.

A driving wheel 24 is rotatably engaged with a groove 11 defined in the inner ring 12 and a shaft extends through a center of the driving wheel 24, each of two ends of the shaft is connected to a crank and a pedal 25 which are located on two sides of the driving wheel 24 which is driven by rotating the crank and the pedal 25 via a transmission mechanism. Two circular sub-frames 22 having a diameter smaller than a diameter of the inner ring 12 are located on two sides of the circular frame. Three rollers 21 are connected to the two sub-frames 22 and rotatably engaged with the groove 11 in the inner ring 12. The three rollers 21 are located at equal-angularly and on a common plane. A bench 23 and two handles 26 (only one is shown) are connected to the sub-frames 22, so that a player can sit in a chair 27 on the bench 23 and operate the pedals 25.

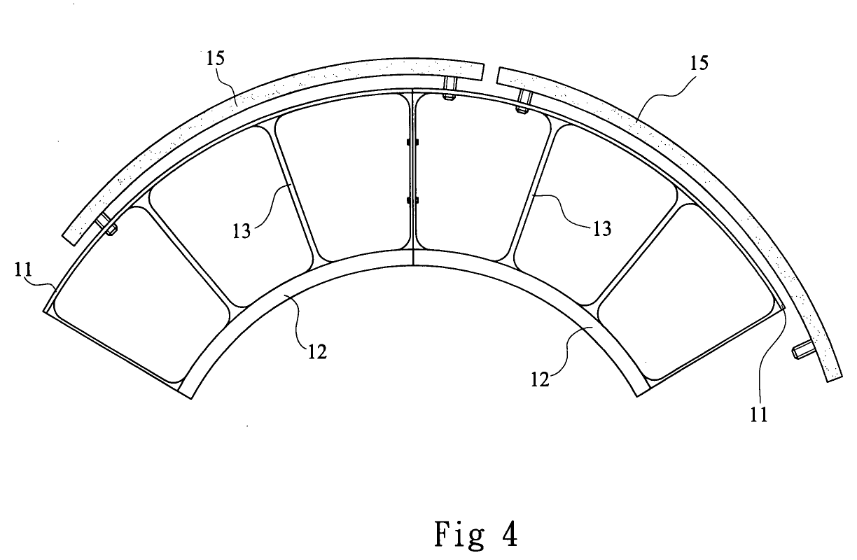

Referring to FIG. 4, another embodiment of the present invention is that each of the section of tires 15 has one end thereof fixed to one of two adjacent sections of the outer rings 11 and the other end of the each of the section of tires 15 is connected to the other section of the outer ring 11. This reinforces the structural strength of the circular frame.

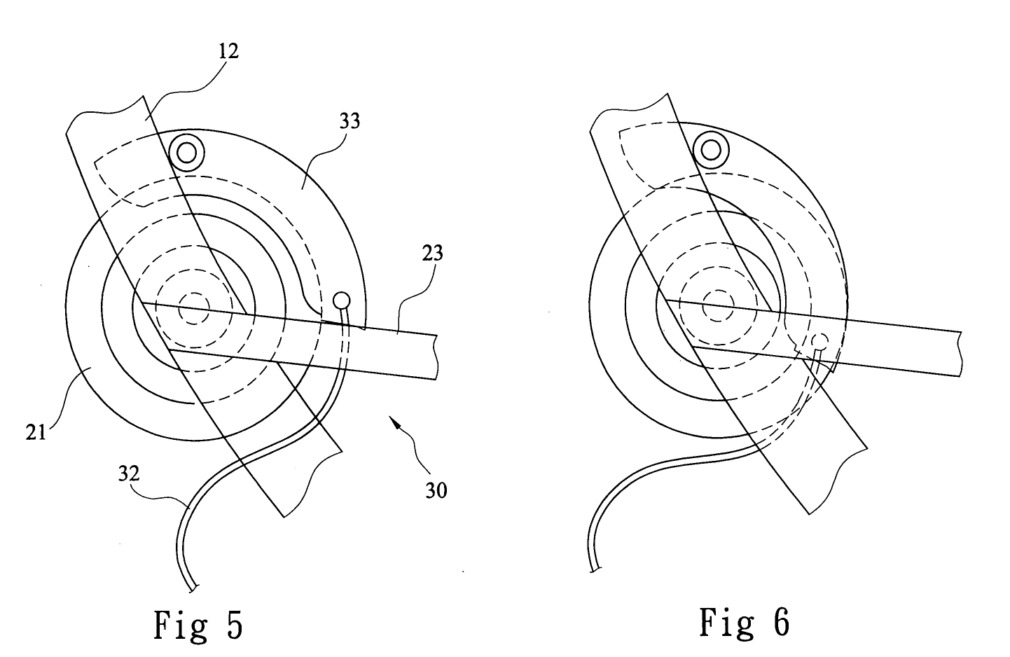

Referring to FIGS. 5 and 6, a brake mechanism 30 is connected to the inner ring 12 and includes a brake member 33 which has one end pivotably connected to the inner ring 22 and a cable 32 is connected to the other end of the brake member 33. The cable 32 is connected to a brake lever 31 on one of the handles 26, and the brake member 33 is pivoted to contact the roller 21 when the brake lever 31 is pulled.

While we have shown and described the embodiment in accordance with the present invention, it should be clear to those skilled in the art that further embodiments may be made without departing from the scope of the present invention.

1. A unicycle comprising:
a circular frame composed of at least two sectors connected with each other, each sector including a section of an outer ring, a section of an inner ring, a plurality of spokes connected between the outer and inner rings, and a section of a tire engaged with the outer ring, a driving wheel rotatably engaged with a groove defined in the inner ring, a shaft extending through a center of the driving wheel and driven by two crank and pedals on two sides of the driving wheel, two circular sub-frames located on two sides of the circular frame and three rollers connected to the two sub-frames and rotatably engaged with the groove in the inner ring, a bench and two handles connected to the sub-frames, a brake mechanism connected to the inner ring so as to brake one of the three rollers.

2. The unicycle as claimed in claim 1, wherein the brake mechanism includes a brake member which has one end pivotably connected to the inner ring and a cable is connected to the other end of the brake member, the cable is connected to a brake lever on one of the handles, the brake member being pivoted to contact the roller when the brake lever is pulled.

3. The unicycle as claimed in claim 1, wherein a number of the sectors is from 2 to 12.

4. The unicycle as claimed in claim 1, wherein each of the section of tires has one end thereof fixed to one of two adjacent sections of the outer rings and the other end of the each of the section of tires is connected to the other section of the outer ring.
